(19) United States
(12) Patent Application Publication
(10) Pub. No.: US 2004/0066601 A1
(43) Pub. Date: Apr. 8, 2004

(54) Electrode configuration for retaining cooling gas on electrostatic wafer clamp

(75) Inventor: Grant Kenji Larsen, Gloucester, MA (US)

Correspondence Address: Mark A. Superko, Esq., Varian Semiconductor Equipment Associates, Inc., 35 Dory Road, Gloucester, MA, 01930, US

(73) Assignee: Varian Semiconductor Equipment Associates, Inc., Gloucester, MA

(21) Appl. No.: 10/264,985

(22) Filed: Oct. 4, 2002

(51) Int. Cl. H02H 1/00

(52) U.S. Cl. 361/234

(57) ABSTRACT

Apparatus for electrostatic clamping of a semiconductor wafer includes a dielectric element that defines a clamping surface for receiving the semiconductor wafer and two or more electrodes, including a first electrode disposed at or near a periphery of the clamping surface and a second electrode disposed inwardly of the first electrode. The first and second electrodes have variable widths that form interdigitated projections along adjacent sides of the first and second electrodes. The interdigitated projections limit flexing of the wafer at or near its outer periphery and thereby enhance retention of cooling gas between the semiconductor wafer and the clamping surface.

### FIELD OF THE INVENTION

This invention relates to apparatus for electrostatic clamping of workpieces, such as semiconductor wafers, in a vacuum processing chamber and, more particularly, to electrostatic clamping apparatus which has an electrode configuration that enhances retention of a cooling gas between the workpiece and a clamping surface. The apparatus is particularly useful in ion implantation systems, but is not limited to such use.

### BACKGROUND OF THE INVENTION

In the fabrication of the integrated circuits, a number of well-established processes involve the application of ion beams to semiconductor wafers in vacuum. These processes include, for example, ion implantation, ion beam milling and reactive ion etching. In each instance, ions are generated in a source and are applied to a target wafer.

The target mounting site is a critical component of an ion implantation system or other ion beam system. The target mounting site is required to firmly clamp a semiconductor wafer to a platen for ion implantation and, in most cases, to provide cooling of the wafer. In addition, a wafer handling system is provided for loading wafers onto the target mounting site and for removing the wafers after completion of ion implantation.

Cooling of wafers is particularly important in commercial semiconductor processing, wherein a major objective is to achieve high throughput in terms of wafers processed per unit time. One way to achieve high throughput is to use high current ion beams, so that the ion implantation process is completed in a relatively short time. However, large amounts of heat are likely to be generated by the high current ion beam. The heat can result in uncontrolled diffusion of impurities beyond described limits in the wafer and in degradation of patterned photoresist layers. It is usually necessary to provide wafer cooling in order to limit the maximum wafer temperature to about 100° C.

A number of techniques for clamping a semiconductor wafer at the target mounting site are known in the art. One technique that has gained favor involves the use of electrostatic forces. A dielectric layer is located between a semiconductor wafer and one or more electrodes. A voltage is applied to the electrodes, and the wafer is clamped against the dielectric layer by electrostatic forces. Electrostatic wafer clamps are disclosed, for example, in U.S. Pat. No. 5,452,177 issued Sep. 19, 1995 to Frutiger and U.S. Pat. No. 5,969,934 issued Oct. 19, 1999 to Larsen.

An electrostatic wafer clamp which utilizes four electrodes of roughly spiral shape is disclosed in U.S. Pat. No. 5,822,172 issued Oct. 13, 1998 to White. Gas inlets are provided for introduction of a gas between the clamping surface and the wafer. A four-phase trapezoidal waveform is applied to the four electrodes to provide electrostatic clamping.

In the four-phase electrostatic clamp described in U.S. Pat. No. 5,822,172, the voltages applied to individual electrodes pass through zero on each half cycle, thereby causing the clamping force produced by that electrode to drop to zero. During those times, clamping force is applied to the wafer by other electrodes as a result of the phase-shifted clamping voltages. However, the loss of clamping force by the electrode at the outer periphery of the clamping surface can cause the periphery of the wafer to flex upwardly from the clamping surface, thereby permitting cooling gas to escape into the vacuum chamber. Such loss of cooling gas can result in excessive heating of a region at the outer periphery of the wafer.

Accordingly, there is a need for improved techniques and electrostatic clamp structures for limiting leakage of a cooling gas from the periphery of electrostatic wafer clamps.

### SUMMARY OF THE INVENTION

According to a first aspect of the invention, apparatus is provided for electrostatic clamping of a semiconductor wafer. The apparatus comprises a dielectric element that defines a clamping surface for receiving a semiconductor wafer, and two or more electrodes, including a first electrode disposed at or near a periphery of the clamping surface and a second electrode disposed inwardly of the first electrode. The first and second electrodes have variable widths that form interdigitated projections along adjacent sides of the first and second electrodes.

The interdigitated projections may be substantially uniformly spaced and may be configured to limit wafer flexing when a voltage is applied to one of the electrodes. The interdigitated projections may have a wave-like configuration. In some embodiments, the wave-like configuration of projections has a relatively small amplitude to wavelength ratio.

The apparatus may further comprise a voltage source for applying phase-shifted clamping voltages to the two or more electrodes, so that the semiconductor wafer is electrostatically clamped to the clamping surface. The clamping voltages may comprise bipolar square wave voltages or trapezoidal voltages.

The apparatus may further comprise one or more gas inlets on the clamping surface and a cooling gas source coupled to the gas inlets for supplying a cooling gas between the semiconductor wafer and the clamping surface. The interdigitated projections limit flexing of the wafer at or near its outer periphery and thereby enhance retention of the cooling gas between the semiconductor wafer and the clamping surface.

According to another aspect of the invention, apparatus is provided for electrostatic clamping of a workpiece. The apparatus comprises at least two electrodes including strip-like conductors disposed side-by-side and electrically isolated from each other, a dielectric element disposed on the at least two electrodes, the dielectric element defining a clamping surface for receiving a workpiece, and a clamping voltage source for applying phase-shifted clamping voltages to the at least two electrodes, wherein the workpiece is electrostatically clamped to the clamping surface. The strip-like conductors have variable widths that form interdigitated projections along adjacent sides thereof.

According to a further aspect of the invention, a method is provided for electrostatic clamping of a workpiece. The method comprises providing two or more electrodes electrically isolated from a clamping surface for receiving a workpiece, the electrodes including a first electrode disposed at or near a periphery of the clamping surface and a second electrode disposed inwardly of the first electrode, wherein the first and second electrodes have variable widths that form interdigitated projections along adjacent side edges of the first and second electrodes, and applying phase-shifted clamping voltages to the first and second electrodes, wherein the workpiece is electrostatically clamped to the clamping surface.

### BRIEF DESCRIPTION OF THE DRAWINGS

For a better, understanding of the present invention, reference is made to the accompanying drawings, which are incorporated herein by reference and in which:

FIG. 1 is a schematic cross-sectional diagram of an example of an electrostatic wafer clamp incorporating gas cooling;

FIG. 2 is a schematic top view of the electrostatic wafer clamp, showing an example of an electrode configuration;

FIG. 3 is a timing diagram showing an example of phase-shifted clamping voltages applied to the electrodes of the electrostatic wafer clamp and the resulting net clamping force;

FIG. 4 is a partial cross-sectional view of the electrostatic wafer clamp, illustrating wafer lifting at the periphery of the clamping surface;

FIG. 5 is a partial top view of an electrode configuration in accordance with an embodiment of the invention, illustrating first and second electrodes having interdigitated projections;

FIG. 6 is an enlarged partial top view of the electrode configuration of FIG. 5;

FIG. 7A is a partial cross-sectional view of the electrode configuration of FIG. 5, taken along an arc-shaped line through the interdigitated projections and illustrating the case where a voltage is applied to the first electrode; and

FIG. 7B is a partial cross-sectional view of the electrode configuration of FIG. 5, taken along an arc-shaped line through the interdigitated projections and illustrating the case where a voltage is applied to the second electrode.

### DETAILED DESCRIPTION

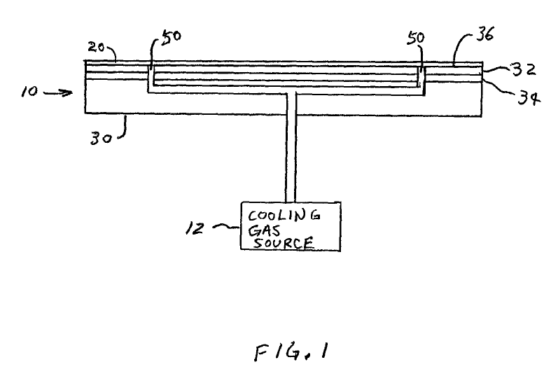

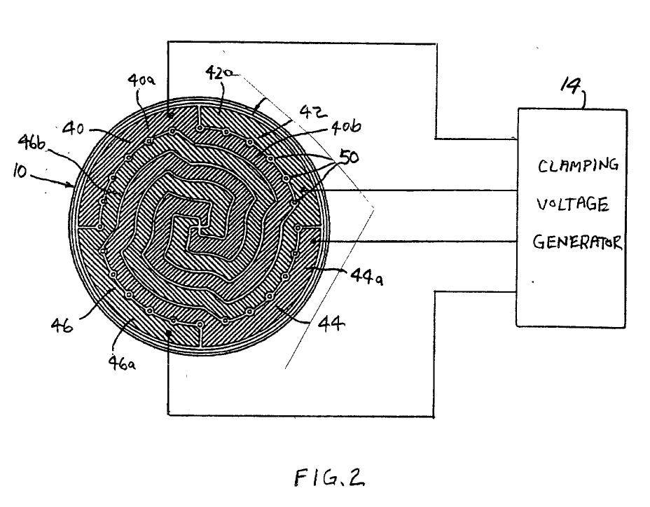

An example of apparatus for electrostatic clamping of a workpiece, such as a semiconductor wafer, is shown in simplified form in FIGS. 1 and 2. An electrostatic wafer clamping apparatus includes a platen 10, a cooling gas source 12 and a clamping voltage generator 14. Clamping voltage generator 14 applies clamping voltages to platen 10 when clamping of a semiconductor wafer 20 or other workpiece is desired.

Platen 10 includes a platen base 30 and dielectric layers 32 and 34 on platen base 30. Dielectric layer 32 defines a clamping surface 36 for receiving semiconductor wafer 20. Electrodes 40, 42, 44 and 46, as shown in FIG. 2, are electrically isolated from clamping surface 36. Electrodes 40, 42, 44 and 46 may be thin conductive layers between dielectric layers 32 and 34 (FIG. 1). Additional details of platen construction are provided in U.S. Pat. No. 5,969,934, which is hereby incorporated by reference. Electrodes 40, 42, 44 and 46 are connected to clamping voltage generator 14.

Cooling gas source 12 is connected to clamping surface 36 of platen 10 to provide a cooling gas between wafer 20 and clamping surface 36. The cooling gas may be introduced through a single gas inlet or through a multiplicity of gas inlets in clamping surface 36. In one embodiment, the cooling gas is introduced through a multiplicity of gas inlets 50 arranged in a circular pattern. It will be understood that different arrangements of gas inlets 50 may be utilized. The cooling gas may be a gas such as air, nitrogen, helium, argon or carbon dioxide, for example, with a pressure typically in the range of about 0.1 to 50 torr.

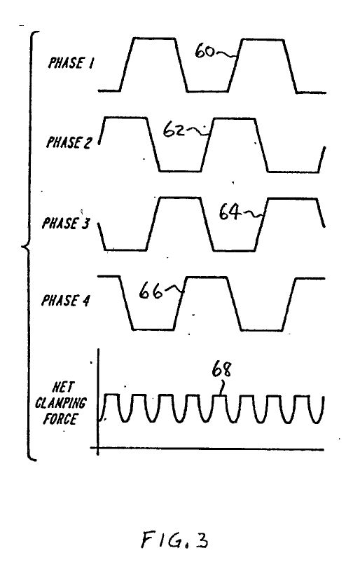

An example of suitable clamping voltage waveforms is shown in FIG. 3. Waveforms 60, 62, 64 and 66 may be trapezoidal voltages as shown or square wave voltages. The waveforms are preferably bipolar and are substantially identical except for being phase shifted with respect to each other. Thus, for example, waveforms 60 and 66 are of opposite phase, i.e., phase shifted by one-half cycle, and waveforms 62 and 64 are of opposite phase. Further, waveforms 60 and 62 are phase shifted by one-quarter cycle. Waveforms 60, 62, 64, and 66 may have peak-to-peak amplitudes in a range of about 900 to 1200 volts and a frequency in a range of about 1 to 300 Hz. The net clamping force applied to wafer 20 is represented by waveform 68 in FIG. 3. As shown, the net clamping force decreases during the voltage switching intervals.

In the embodiment of FIGS. 1 and 2, electrodes 40, 42, 44 and 46 each have an approximately spiral shape extending from the outer periphery of platen 10 to its center. The electrodes are spaced apart from each other and are relatively long in comparison with their widths. Additional details regarding the electrode configuration of FIG. 2 are provided in U.S. Pat. No. 5,822,172, which is hereby incorporated by reference.

In one application, the electrostatic clamping apparatus of FIGS. 1 and 2 is used for clamping semiconductor wafers in a vacuum processing system. For example, platen 10 may be part of a platen assembly in an ion implantation system. The platen assembly clamps the semiconductor wafer in position during ion implantation and provides cooling of the semiconductor wafer. It will be understood that the electrostatic clamping apparatus is not limited to use in ion implantation systems, is not limited to use with semiconductor wafers and is not limited to use in vacuum.

In the electrode configuration of FIG. 2, it may be observed that each of electrodes 40, 42, 44 and 46 extends around part of the outer periphery of clamping surface 36, with each electrode occupying approximately one-quarter of the outer periphery. Thus, first electrode portions 40a, 42a, 44a and 46a extend around the outer periphery of clamping surface 36, and second electrode portions 40b, 42b, 44b, 46b are located inwardly of each outer electrode portion. Adjacent first and second electrode portions are parts of different electrodes. Thus, for example, second electrode portion 46b is located inwardly of first electrode portion 40a, second electrode portion 40b is located inwardly of first electrode portion 42a, etc. The electrode configuration shown in FIG. 2 may have a problem of gas retention near the outer periphery of clamping surface 36.

Referring to FIG. 4, a partial radial cross-sectional view of an outer peripheral region of platen 10 is shown. FIG. 4 illustrates a cross-section of platen 10 where electrode portion 40a is located at the outer periphery of clamping surface 36, electrode portion 46b is located inwardly of electrode portion 40a, and electrode portion 44c is located inwardly of electrode portion 46b. Gas inlet 50 may be located between electrode portions 40a and 46b. The clamping voltages shown in FIG. 3 and described above are applied to the electrodes. Twice during each cycle the clamping voltages pass through zero volts. FIG. 4 illustrates an instant when electrode 40 is at zero volts, electrode 46 is at a positive voltage, +V, and electrode 44 is at a negative voltage, −V. As the trapezoidal or square wave voltage on each electrode transitions from positive through zero to negative and from negative through zero to positive, there are portions of each cycle when the electrode voltage is relatively small. An outer periphery of wafer 20 may flex upwardly, as shown in FIG. 4, during those portions of each clamping voltage cycle when the voltage on electrode 40 is insufficient to overcome the flexing force in wafer 20. The upward flexing at the periphery of wafer 20 may allow cooling gas to escape from the region between wafer 20 and clamping surface 36. The escape of cooling gas can result excessive heating of wafer 20, particularly in an annular region at its outer periphery.

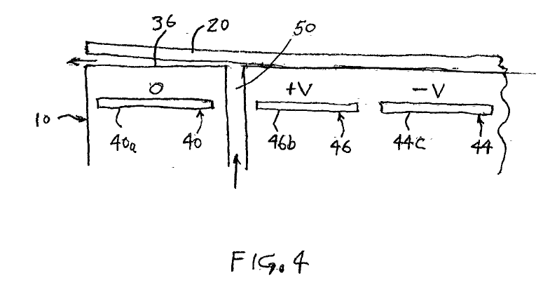

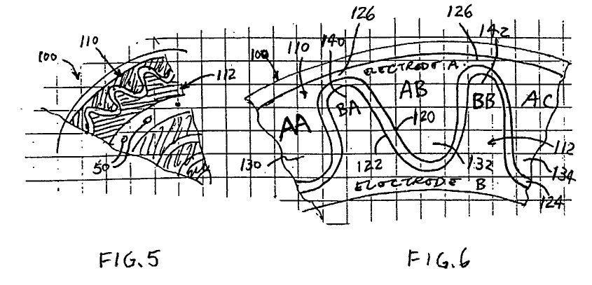

An electrode configuration for inhibiting wafer flexure near the outer periphery of the electrostatic wafer clamp and limiting the escape of cooling gas is shown in FIGS. 5-7B. Like elements in FIGS. 1-7B have the same reference numerals. A sector-shaped part of a platen 100 is shown in FIG. 5, and an enlarged view of the outer periphery of platen 100 is shown in FIG. 6. The platen 100 may be similar to the platen 10 described above except for the electrode configuration. In the embodiment of FIGS. 5-7B, platen 100 is provided with a first electrode 110 disposed at or near an outer periphery of clamping surface 36 and a second electrode 112 disposed inwardly of electrode 110 in a side-by-side relation to the first electrode 110. Electrodes 110 and 112 are elongated in a circumferential direction of platen 100 to form strip-like conductors and extend side-by-side along at least a part of the periphery of platen 100. The portions of electrodes 110 and 112 shown in FIGS. 5 and 6 are generally arc-shaped. Gas inlets 50 may be located inwardly of electrodes 110 and 112.

An inside edge 120 of first electrode 110 and an outside edge 122 of second electrode 112 are spaced apart and are configured to have interdigitated projections. In particular, first electrode 110 is provided with projections 130, 132, 134, etc., and second electrode 112 is provided with projections 140, 142, etc. The projections on electrodes 110 and 112 are interdigitated in the sense that projection 140 on electrode 112 is located in a recess between projections 130 and 132 of electrode 110, projection 132 on electrode 110 is located in a recess between projections 140 and 142 of electrode 112, etc. Electrodes 110 and 112 have variable widths that define the interdigitated projections. An outside edge of electrode 110 and an inside edge of electrode 112 may be arc-shaped or nearly arc-shaped in the typical case of a circular platen. A space 124 between the inside edge of electrode 110 and the outside edge 122 of electrode 112 along the interdigitated projections ensures electrical isolation between electrodes.

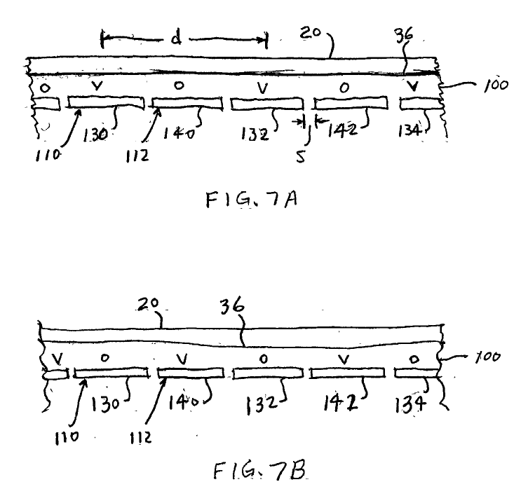

FIGS. 7A and 7B are arc-shaped sections through the interdigitated projections of electrodes 110 and 112. FIG. 7A illustrates an instant when electrode 110 is at voltage V and electrode 112 is at zero volts. FIG. 7B illustrates an instant when electrode 110 is at zero volts and electrode 112 is at voltage V. As noted above, there are portions of each clamping voltage cycle when the voltage is insufficient to prevent upward flexing of wafer 20. During the portions of each clamping voltage cycle when the voltage applied to electrode 112 is insufficient to prevent upward flexing of wafer 20 (FIG. 7A), wafer 20 is clamped against clamping surface 36 by the voltage applied to projections 130, 132, 134, etc. of electrode 110. Similarly, during the portions of each clamping voltage cycle when the voltage applied to electrode 110 is insufficient to prevent upward flexing of wafer 20 (FIG. 7B), wafer 20 is clamped against clamping surface 36 by the voltage applied to projections 140, 142, etc. of electrode 112. If the center-to-center distance d between projections on the same electrode, e.g., projections 130 and 132 on electrode 110, is sufficiently small, flexure of wafer 20 at the periphery of clamping surface 36 is substantially eliminated. Thus, for example, the clamping voltage applied to projections 130 and 132 in FIG. 7A maintains wafer 20 flat against clamping surface 36 in a region adjacent to projection 140, even during portions of the clamping voltage cycle when the voltage applied to projection 140 is insufficient for clamping.

The required center-to-center distance d to substantially eliminate wafer flexure depends upon a number of parameters including, but not limited to, the material, thickness and stiffness of wafer 20, the amplitude and frequency of the voltages applied to electrodes 110 and 112, the material of dielectric layers 32 and 34 and the desired cooling rate. In selecting a center-to-center distance, consideration must also be given to the range of parameter values exhibited by wafers of a particular type. A spacing S between electrodes 110 and 112 is selected to limit the risk of arcing between electrodes and may, for example, be about 1 millimeter. In one embodiment, the spacing S may be constant along the lengths of the electrodes. However, the projections 130, 140, 132, 142, etc. are not required to be of equal size or to have uniform spacing.

The interdigitated projections 130, 140, 132, 142, etc. may have a variety of configurations. In one embodiment, the interdigitated projections have a sinusoidal or nearly sinusoidal shape along an arc-shaped curve corresponding to the radius of platen 10. In another embodiment, the interdigitated fingers have rectangular or nearly rectangular shapes along the arc-shaped curve of platen 100. In the interdigitated projections, sharp corners preferably are avoided to minimize the risk of arcing between adjacent electrodes. The radial dimension of the interdigitated projections is preferably selected to ensure that the outer periphery of wafer 20 is securely clamped against clamping surface 36.

In some embodiments, the interdigitated projections may have a sinusoidal or wave-like configuration with a relatively small amplitude to wavelength ratio. In determining the amplitude to wavelength ratio of the wave-like configuration of projections, the amplitude corresponds to the radial dimension of the projections and the wavelength corresponds to the center-to-center distance d between projections. By way of example only, the amplitude of the wave-like configuration of projections may be less than 0.5 inch and the wavelength may be on the order of 1.0 to 1.3 inches. The wavelength of the projections may be fixed or may be variable around the periphery of the clamping surface, depending for example on spatial variations in wafer characteristics. Further, connections 126 between projections 130, 132, 134 of first electrode 110 at the outer periphery of clamping surface 36 are preferably minimized in radial dimension to ensure clamping of wafer 20 at its outer edge. In one example, connections 126 may have a radial dimension of about 1 millimeter.

The interdigitated projections are configured such that a clamping voltage is applied to the wafer at spaced-apart regions along the periphery of the clamping surface, even when the voltage applied to electrode 110 at the outer periphery of the clamping surface is zero. The geometry of the interdigitated projections and the parameters of the clamping voltages are selected to limit flexing of the wafer between the spaced-apart regions.

The electrode configuration of FIGS. 5-7B has been described in connection with a platen of the type shown in FIG. 2 which utilizes approximately spiral electrodes. However, the invention may be utilized with any electrostatic clamp having circumferential electrodes along all or part of the outer periphery of the clamping surface to ensure that the wafer is securely clamped at its periphery to the clamping surface and to inhibit escape of cooling gas.

Having thus described at least one illustrative embodiment of the invention, various modifications and improvements will readily occur to those skilled in the art and are intended to be within the scope of the invention. Accordingly, the foregoing description is by way of example only and is not intended as limiting. The invention is limited only as defined in the following claims and the equivalents thereto.

What is claimed is:

1. Apparatus for electrostatic clamping of a semiconductor wafer, comprising:
a dielectric element that defines a clamping surface for receiving a semiconductor wafer; and
two or more electrodes electrically isolated from said clamping surface, said electrodes including a first electrode disposed at or near a periphery of said clamping surface and a second electrode disposed inwardly of said first electrode, wherein said first and second electrodes have variable widths that form interdigitated projections along adjacent sides of said first and second electrodes.

2. Apparatus as defined in claim 1, wherein the interdigitated projections are smoothly curved.

3. Apparatus as defined in claim 1, wherein the interdigitated projections are substantially uniformly spaced.

4. Apparatus as defined in claim 1, wherein the interdigitated projections are spaced to limit wafer flexing when a voltage is applied to one of the electrodes.

5. Apparatus as defined in claim 1, wherein said first and second electrodes are strip-like and are relatively long and thin.

6. Apparatus as defined in claim 1, wherein said clamping surface is substantially circular.

7. Apparatus as defined in claim 6, wherein the interdigitated projections are formed on generally arc-shaped portions of said first and second electrodes.

8. Apparatus as defined in claim 1, further comprising a voltage source for applying phase-shifted clamping voltages to said two or more electrodes, wherein the semiconductor wafer is electrostatically clamped to said clamping surface.

9. Apparatus as defined in claim 8, wherein said clamping voltages comprise bipolar square wave voltages or trapezoidal voltages.

10. Apparatus as defined in claim 1, further comprising one or more gas inlets on said clamping surface.

11. Apparatus as defined in claim 10, further comprising a cooling gas source coupled to said gas inlets for supplying a cooling gas between the semiconductor wafer and said clamping surface.

12. Apparatus as defined in claim 1, wherein the interdigitated projections have a wave-like configuration.

13. Apparatus as defined in claim 12, wherein the wave-like configuration of projections has a relatively small amplitude to wavelength ratio.

14. Apparatus for electrostatic clamping of a workpiece, comprising:
at least two electrodes comprising strip-like conductors disposed side-by-side and electrically isolated from each other, said strip-like conductors having variable widths that form interdigitated projections along adjacent sides thereof;
a dielectric element disposed on said at least two electrodes, said dielectric element defining a clamping surface for receiving a workpiece; and
a clamping voltage source for applying phase-shifted clamping voltages to said at least two electrodes, wherein the workpiece is electrostatically clamped to said clamping surface.

15. Apparatus as defined in claim 14, wherein said clamping voltages comprise square wave voltages.

16. Apparatus as defined in claim 14, wherein said clamping surface is provided with one or more gas inlets.

17. Apparatus as defined in claim 16, further comprising a cooling gas source coupled to said gas inlets for providing a cooling gas between the workpiece and said clamping surface.

18. Apparatus as defined in claim 14, wherein the interdigitated projections have a wave-like configuration.

19. Apparatus as defined in claim 18, wherein the wave-like configuration of projections has a relatively small amplitude to wavelength ratio.

20. A method for electrostatic clamping of a workpiece, comprising:
providing two or more electrodes electrically isolated from a clamping surface for receiving a workpiece, said electrodes including a first electrode disposed at or near a periphery of the clamping surface and a second electrode disposed inwardly of the first electrode, wherein the first and second electrodes have variable widths that form interdigitated projections along adjacent side edges of the first and second electrodes; and
applying phase-shifted clamping voltages to the first and second electrodes, wherein the workpiece is electrostatically clamped to the clamping surface.

21. A method as defined in claim 20, wherein applying phase-shifted clamping voltages comprises applying bipolar square wave voltages or trapezoidal voltages.

22. A method as defined in claim 20, further comprising supplying a cooling gas between the workpiece and the clamping surface.

23. A method as defined in claim 20, wherein providing two or more electrodes comprises providing interdigitated projections having a wave-like configuration.
